(19) United States
(12) Patent Application Publication
(10) Pub. No.: US 2026/0308969 A1
(43) Pub. Date: Oct. 8, 2026

(54) ACTUATOR FOR A VEHICLE DOOR OR A VEHICLE PANEL, HAVING AN ADJUSTABLE BRAKE DEVICE

(71) Applicant: Edscha Mechatronics Solutions GmbH, Remscheid (DE)

(72) Inventors: Jörg DÖRNEN, Remscheid (DE); Christoph SCHMIDT, Remscheid (DE); Volker BOLTE, Remscheid (DE); Jochen BALS, Remscheid (DE)

(21) Appl. No.: 19/478,746

(22) PCT Filed: Apr. 18, 2024
(86) PCT No.: PCT/DE2024/100337

§ 371 Date: Oct. 24, 2025

(30) Foreign Application Priority Data
Apr. 27, 2023 (DE) 10 2023 110 938.3

(51) Int. Cl. E05F 15/622

(52) U.S. Cl. CPC E05F 15/622; E05Y 2201/21; E05Y 2201/266; E05Y 2201/408; E05Y 2900/531

(57) ABSTRACT

An actuator for a vehicle door or a vehicle panel, including: a housing having at least one first housing part; a drive unit arranged in the housing including a driveshaft which can rotate about a drive axis; and a brake device arranged in the housing for braking the driveshaft or an actuation element driven by the driveshaft, the brake device including a first brake element, rotatably arranged in the housing, and a second brake element, non-rotatably arranged in the housing, the first brake element and the second brake element interacting to generate a brake torque, and the generated brake torque being adjustable by moving an adjustment element along an adjustment axis. An actuator, including a brake device to provide brake torque, and a method for adjusting a brake torque generated by a brake device in an actuator, which can be carried out in a fully assembled actuator are provided.

The present disclosure relates to an actuator for a vehicle door or a vehicle panel, comprising a housing with at least a first housing part, a drive unit arranged in the housing, and a brake device arranged in the housing for braking the rotation of the driveshaft or of an actuation element driven by the driveshaft.

### BACKGROUND

Actuators for doors or panels of vehicles are known from practice, which enable a vehicle panel or a vehicle door to be opened and closed between a closed and an open position during normal operation. Such actuators often also have a brake device which serves to quickly bring to a standstill the adjustment of the vehicle door or the vehicle panel initiated by a drive unit arranged in the actuator when the drive unit is switched off and which is generally also provided to relieve the drive unit, since the brake device also absorbs part of the weight load of the vehicle door or the vehicle panel. The brake torque of the brake device is adjusted depending upon the installation situation of the actuator and the vehicle door or vehicle panel to be driven in order to ensure the desired effect of relieving the drive unit in every intermediate position of the vehicle door or vehicle panel. In addition, the brake device also serves as a continuously acting door holder which ensures that, even in the event of a drive unit failure, the vehicle door is not moved unbraked due to its own weight and can only be moved by applying appropriate manual force.

EP 3 649 376 B1 discloses an actuator for a vehicle panel, wherein the actuator comprises a housing with a first housing part, wherein a drive unit designed as an electric motor with a driveshaft which can rotate about a drive axis is arranged in the housing part. The driveshaft is coupled via a gearbox to a gearbox element designed as a spindle rod. Furthermore, the actuator comprises a brake device arranged in the housing part for braking the rotation of the gearbox element driven by the driveshaft. The brake device comprises a first brake element which is coupled in a rotationally fixed manner to the spindle rod and a second brake element which is inserted in a rotationally fixed manner into the housing part, wherein a brake torque generated by the brake device is achieved by moving the first brake element relative to the second brake element. The movement is carried out by means of an electromagnet which can move or preload the first brake element in the direction of the second brake element and can thereby cause both a complete release of the two brake elements and an increase or decrease in the brake torque by correspondingly actuating the electromagnet.

DE 20 2018 101 761 U1 discloses an actuator for a pivotable vehicle panel or a vehicle door, comprising a housing with at least a first housing part, a drive unit arranged in the first housing part with a driveshaft which can rotate about a drive axis, and a brake device arranged in the housing for braking the rotation of a gearbox element designed as a spindle rod and driven by the driveshaft. The brake device is designed as a multi-disk brake and comprises a preloading means designed as a compression spring, which rests with a first end on a stop part screwed into a brake housing part, which stop part is designed to be annular and has an external thread which engages with an internal thread provided on an internal diameter of the brake housing part. A second end of the preloading means rests against a brake element so that the preloading means preloads this brake element onto another brake element and therefore determines the brake torque generated by the brake device. The brake device can be adjusted by moving the stop part serving as an adjustment element by screwing the stop part farther or less far into the brake housing part.

DE 10 2019 105 842 A1 discloses an actuator for a vehicle panel, comprising a housing with a housing part, wherein a drive unit with a driveshaft which can rotate about a drive axis is arranged in the housing part. Furthermore, the actuator comprises a brake device arranged in the housing part for braking the driveshaft, wherein the brake device comprises a first brake element arranged rotatably in the housing and a second brake element arranged non-rotatably in the housing, which cooperate frictionally to generate a brake torque. The brake torque can be adjusted by moving an adjustment element of an adjusting device along an adjustment axis. The adjustment element is designed as a screw and is inserted into an opening provided in the housing part, wherein the movement of the adjustment element along the adjustment axis can be carried out by a screwing movement.

DE 10 2022 116 871 A1 discloses an actuator for a vehicle door or a vehicle panel, comprising a housing with a first housing part and a second housing part. A free end of a driveshaft which can rotate about a drive axis is arranged in the housing, wherein the driveshaft is coupled to a transmission shaft via a gearbox. To brake the transmission shaft driven by the driveshaft, the actuator comprises a brake device which comprises a brake element pre-tensioned onto the transmission shaft by a spring. The brake element is rotationally fixed relative to the housing and can also be displaced radially in the direction of the transmission shaft. To adjust the preload of the spring and therefore the brake torque, an actuation element designed as a screw is adjustable in an opening, provided with an internal thread, in the housing part, wherein the spring is clamped between the actuation element and the brake element.

DE 10 2018 131 966 A1 discloses an actuator for a vehicle panel, comprising a housing and a drive unit, wherein the drive unit comprises a driveshaft which can rotate about a drive axis. Furthermore, the actuator comprises a brake device for braking a rotation of a spindle rod rotatably arranged in the housing, wherein the brake device has a first brake disc which is non-rotatably coupled to the spindle rod and a brake pad which is non-rotatably coupled to the housing and which cooperates with the brake disc to generate a brake torque. Furthermore, the actuator comprises an adjustment device for adjusting the brake torque of the brake device. The adjustment device comprises an adjustment element which is designed as a screw, wherein a helical spring is arranged between the adjustment element and the brake pad so that the brake torque can be adjusted by a screwing movement of the adjustment element and the associated movement of the adjustment element along an adjustment axis.

DE 10 2017 107 839 A1 discloses an actuator for a vehicle panel, comprising a housing part, a drive unit with a driveshaft which can rotate about a drive axis, and a brake device for braking a spindle driven by the drive unit. The brake device comprises a friction lever which is in frictional contact with the spindle and therefore generates a brake torque. The preload of the friction lever against the spindle is provided by a spring, wherein the preload force can be adjusted via a screw.

### SUMMARY

It is an object of the present disclosure to create an actuator, which comprises a brake device which can be reliably and flexibly optimized with respect to the provided brake torque. Furthermore, it is the object of the present disclosure to provide a method for adjusting a brake torque generated by a brake device in an actuator, which can be carried out easily and cost-effectively and can also be retroactively carried out in a fully assembled actuator.

This object is achieved according to the present invention by an actuator as described and a method thereof.

According to one aspect of the present disclosure, an actuator for a vehicle door or a vehicle panel is created, comprising a housing with at least one first housing part and a drive unit arranged in the housing, wherein the drive unit comprises a driveshaft which can rotate about a drive axis. Furthermore, the actuator comprises a brake device arranged in the housing for braking the driveshaft or an actuation element driven by the driveshaft, wherein the brake device comprises a first brake element rotatably arranged in the housing and a second brake element non-rotatably arranged in the housing, wherein the first brake element and the second brake element cooperate to generate a brake torque, wherein the brake torque generated by the brake device can be adjusted by moving an adjustment element along an adjustment axis. The actuator according to the present disclosure is characterized in that the adjustment element is accessible via an opening, provided in the first housing part, for adjusting the brake torque. Advantageously, the brake torque can be subsequently adjusted in the already fully assembled actuator. In particular, the subsequent adjustment of the brake device ensures that the required brake torques can be adjusted depending upon the vehicle and the slope conditions, such that only one or a few variants of a brake device or actuator are required. Another advantage is that the actuation of the actuator is simplified and the current consumption of the actuator is reduced, and a more precise adjustment can be made depending upon the required holding force for the vehicle panel or the vehicle door. In addition, the drive unit requires fewer reserves because the friction-relevant tolerances of the individual components of the actuator can be compensated for by readjusting the brake torque.

In a preferred embodiment, the adjustment element can be moved by a tool element. The opening is expediently designed to accommodate the tool element.

Advantageously, the tool element has an end portion which is provided for coupling to a manually-driven or motor-driven tool. Particularly preferably, the tool element can be moved or rotated over the end portion using preferably motor-driven tools such as an electric screwdriver. Advantageously, the adjustment element can be moved particularly conveniently by placing this tool on the tool element and actuating the tool element. When the tool element is in an inserted state, the end portion protrudes beyond an upper edge of the opening so that it is accessible for coupling with the tool.

Particularly preferably, the adjustment element can be moved along the adjustment axis by rotating about the adjustment axis. Advantageously, the adjustment element has a coupling portion, which is provided for coupling to a counter-coupling portion arranged on the tool element. The coupling portion is expediently arranged in the region of the opening so that the coupling portion can be coupled to the tool element for coupling. Particularly preferably, an external gear is provided in the coupling portion. Further preferably, in the counter-coupling portion of the tool element, an external thread is provided which can be brought into threaded engagement with the external gear. Advantageously, a movement of the adjustment element can be undertaken particularly precisely along the adjustment axis by making the pitches of the threads sufficiently small.

In a first preferred embodiment, it is provided that the brake device be designed as a hysteresis brake, wherein the first brake element is designed as a multi-pole permanent magnet which is coupled in a rotationally fixed manner to the driveshaft or to a gearbox element coupled to the actuation element, and the second brake element is designed as a film or a layer of a hysteresis material which is connected to the adjustment element. Advantageously, the brake device is designed to be particularly compact and does not require an external power source, since the variable magnetic field required for the braking effect is already generated by the rotation of the driveshaft or the gearbox element itself.

In an alternative second embodiment, it is provided that the brake device be designed as a multi-disk brake, wherein the first brake element is designed as a first brake disc coupled in a rotationally fixed manner to the driveshaft or to a gearbox element, and the second brake element is designed as a second brake disc non-rotatably arranged in the housing. The brake device comprises a pre-tensioning means, preferably designed as a helical compression spring, which is arranged between the brake elements and the adjustment element. The adjustment element is designed as a stop part which determines a preload force of the preloading means by the movement along the adjustment axis and can thereby adjust the brake torque generated by the brake device.

According to a further aspect of the present disclosure, a method is provided for adjusting a brake torque generated by a brake device in an actuator as described above, wherein the method comprises, in a first method step, the determination of an axial force required during an extension and retraction movement of an actuation element provided on the actuator. In a second method step, the measured axial force is compared with a specified target value. In a third method step, a brake torque generated by the brake device is adjusted, wherein the third method step comprises the insertion of a tool element into the opening provided in the first housing part while coupling a coupling portion of the adjustment element to a counter-coupling portion of the tool element. Furthermore, the third method step comprises the actuation of the tool element, wherein the actuation of the tool element leads to a movement of the adjustment element in the housing of the actuator, wherein the tool element is actuated until the brake torque generated by the brake device corresponds to a value predetermined by the target value of the axial force. Advantageously, the brake torque can be adjusted when the actuator is already fully assembled so that the friction tolerances arising within the actuator can be easily subsequently compensated for by adjusting the brake device.

Further advantages, features, and developments of the claimed present disclosure_emerge from the following description of a preferred exemplary embodiment.

### BRIEF DESCRIPTION OF THE FIGURES

The present disclosure is explained in more detail below with reference to the accompanying drawings.

FIG. 1 is a preferred exemplary embodiment of an apparatus according to the present disclosure in a side view.

FIG. 2 is the actuator 1 with the first housing part 3 removed.

FIG. 3 is an enlarged view of the actuator 1 in the region of the brake device 11 with displaced adjustment element 13.

FIG. 4 is a plan view of the cross-section A-A marked in FIG. 1.

FIG. 5 is a plan view of the cross-section B-B marked in FIG. 1.

### DETAILED DESCRIPTION

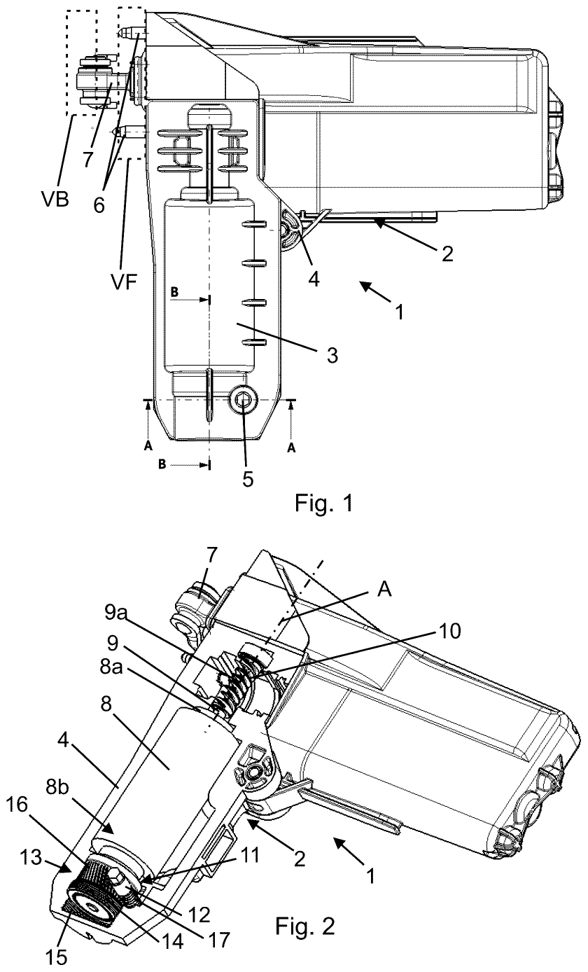

FIG. 1 is a preferred exemplary embodiment of an actuator according to the present disclosure in a side view. The actuator 1 comprises a housing 2, wherein the housing 2 comprises a first housing part 3. The housing 2 further comprises a second housing part 4, wherein the first housing part 3 is arranged on and fastened to the second housing part 4. The first housing part 3 has a tightly sealable opening 5 through which a brake device accommodated in the housing 2, not visible here, can be adjusted with respect to its torque, which will be explained in more detail below. The housing 2 is firmly connected to a vehicle door VF, shown here in dashed lines, via rivet pins 6. To drive a pivoting movement of the vehicle door VF, the actuator has an actuation element 7 which can be telescopically extended from the housing 2 and which is connected in an articulated manner to the vehicle body VB. As a result, an opening movement of the vehicle door VF is driven when the actuation element 7 is extended from the housing 2.

FIG. 2 shows the actuator 1 with the first housing part 3 removed so that the components of the actuator 1 arranged below the first housing part 3 are now visible. As can be seen, the actuator 1 comprises a drive unit 8 arranged in the housing 2 or in the second housing part 4, wherein the drive unit 8 in the present exemplary embodiment here is designed as an electric motor and drives a linear movement of the actuation element 7 via a spindle gear not visible here. At a first end 8a of the drive unit 8, a driveshaft 9 designed as a worm shaft is provided, which can be coupled to the spindle gear not visible here, wherein the spindle gear comprises a first gearbox element, designed as a spindle rod, and a spindle nut in threaded engagement with the spindle rod. The spindle nut is thereby axially moved within the housing 2, wherein the spindle nut is coupled to the actuation element 7 so that the actuation element 7 is moved together with the spindle nut. The driveshaft 9 advantageously has a worm thread 10 at the first end 9a shown here.

At a second end 8b, opposite the first end 8a, of the drive unit 8, a brake device 11 is arranged which is provided for braking the rotational movement of the driveshaft 9 about the drive axis A. The brake device 11 can be adjusted with respect to a brake torque, acting upon the drive unit 8, via a tool element 12, as explained in more detail below.

In the exemplary embodiment shown here, the brake device 11 is designed as a hysteresis brake. Advantageously, in contrast to an eddy current brake, a brake torque is provided by the brake device 11 independently of the rotational speed of the driveshaft 9 of the drive unit 8, so that the adjustment of the brake torque to optimize the driving force to be applied by the drive unit 8 as well as the required holding force for holding the vehicle door on steep slopes between the fully open position and the fully closed position is particularly easy. In particular, it is achieved that the drive unit 8 is relieved by the brake device 11, since the brake device 11 applies the required holding forces for holding the vehicle body of the vehicle door in an intermediate position and therefore reduces the power consumption of the drive unit 8.

The brake device 11 comprises an adjustment element 13 which has an external thread 14 which is in threaded engagement with an internal thread 15 provided in the housing 2. In the state shown here, the adjustment element 13 is displaced in the direction of the drive unit 8, so that the internal thread 15 can be seen. As explained in more detail below, the position of the adjustment element 13 corresponds to a maximum brake torque which acts upon the driveshaft 9 through the brake device 11. Furthermore, the adjustment element 13 has a coupling portion 16 arranged adjacently to the external thread 14, which is provided for coupling to a counter-coupling portion 17 provided on the tool element 12.

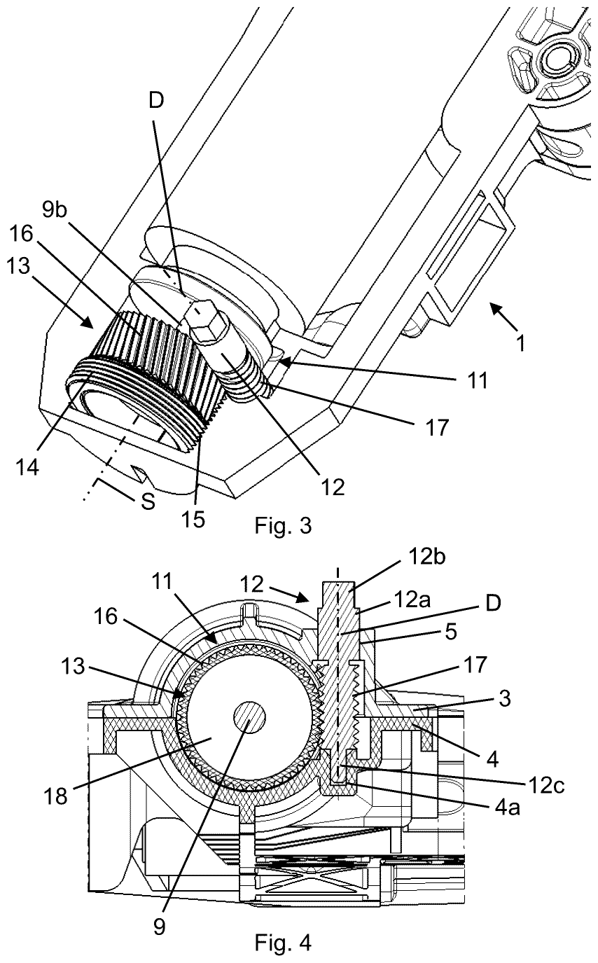

FIG. 3 shows an enlarged view in the region of the brake device 11. Compared to the state shown in FIG. 2, the adjustment element 13 has been displaced away from the drive unit 8 by rotation about an adjustment axis S along the adjustment axis S. As a result, it can be seen in this view that the brake device 11 is coupled to a second end 9b of the driveshaft 9 so that the brake device 11 generates a brake torque on the driveshaft 9. As explained below, due to the movement of the adjustment element 13 along the adjustment axis S, a reduced brake torque is generated compared to the state in FIG. 2.

The rotation of the adjustment element 13 about the adjustment axis S has been driven by rotation of the tool element 12 about an axis of rotation D, wherein the coupling portion 16 of the adjustment element 13 and the counter-coupling portion 17 of the tool element 12 are in threaded engagement. In the exemplary embodiment shown here, the adjustment axis S of the adjustment element 13 and the axis of rotation D of the tool element 12 are perpendicular to each other. The movement of the adjustment element 13 along the adjustment axis S occurs because the external thread 14 of the adjustment element 13 is in threaded engagement with the internal thread 15 of the housing 2. The internal thread 15 is half embedded in the first housing part 3 and the second housing part 4, such that a circumferential internal thread 15 is formed.

FIG. 4 shows a plan view of the cross-section A-A marked in FIG. 1. The cross-section runs perpendicular to the adjustment axis S or the drive axis A and runs through the opening 5 with the tool element 12 accommodated therein. In this view, it can be seen that the tool element 12 has, at an upper end, a bearing portion 12a with an outer diameter which corresponds to an inner diameter of the opening 5. Advantageously, the tool element 12, which can be rotated about the axis of rotation D, is guided through the opening 5 and supported radially. Above the bearing portion 12a, an end portion 12b with a polygonal cross-section is provided, which can be coupled in a rotationally fixed manner to a corresponding tool, e.g., an electrically driven screwdriver, in order to rotate the tool element 12 about its axis of rotation D.

The tool element 12 has at a lower end a cylindrical extension 12c, which is accommodated in a hollow cylindrical bearing point 4a provided in the second housing part 4. Advantageously, the lower end of the tool element 12 is also supported axially and radially, so that it is ensured that the counter-coupling portion 17 arranged between the bearing portion 12a and the cylindrical extension 12c remains in threaded engagement with the coupling portion 16 provided on the adjustment element 13, while the tool element 12 is rotated about the axis of rotation D. The adjustment element 13 rotates radially about a multi-pole permanent magnet 18 which is connected in a rotationally fixed manner to the driveshaft 9 and which is rotated accordingly with the driveshaft 9 about the drive axis A. The multi-pole permanent magnet 18 forms a first brake element of the brake device 11 designed as a hysteresis brake.

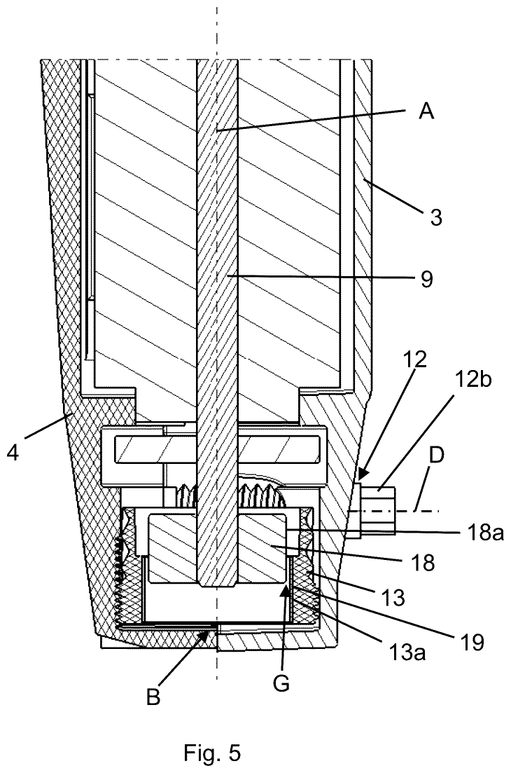

FIG. 5 shows a top view of the cross-section B-B marked in FIG. 1. The cross-section runs parallel to the longitudinal extension of the housing 2 of the actuator 1. In this view, it can be seen that the adjustment element 13 has, on an inner side 13a, facing the permanent magnet 18, which runs parallel to a side surface 18a of the permanent magnet 18, a film 19, made of a hysteresis material, which is spaced apart from the side surface 18a of the permanent magnet 18 by an air gap G. In the exemplary embodiment shown here, the adjustment element 13 is designed as a hollow cylinder which, via the external thread 14, is in threaded engagement with the internal thread 15 provided on both the first housing part 3 as well as the second housing part 4.

In the state shown here, the adjustment element 13 has been displaced completely downwards so that the adjustment element 13 is close to a bottom surface B provided by the first housing part 3 and the second housing part 4. The bottom surface B also serves as a stop surface which limits the movement of the adjustment element 13. It can also be seen that the axial overlap between the foil 19 and the permanent magnet 18 corresponds to slightly less than half of the respective total longitudinal extent of the foil 19 or the permanent magnet 18. As a result, the brake torque generated on the driveshaft 9 by the brake device 11 designed as a hysteresis brake is reduced compared to a situation in which the film 19 and the permanent magnet 18 overlap more, or even completely, axially. Accordingly, by rotating the tool element 12 about the axis of rotation D and the associated movement of the adjustment element 13, the brake torque generated by the brake device 11 can be increased in steps, or reduced or adjusted to a required value.

What is claimed is:

1 to 18 (canceled)

19. An actuator for a vehicle door or a vehicle panel, comprising:
a housing with at least one first housing part;
a drive unit arranged in the housing, wherein the drive unit comprises a driveshaft rotatable about a drive axis; and
a brake device arranged in the housing for braking the driveshaft or an actuation element driven by the driveshaft,
wherein the brake device comprises a first brake element rotatably arranged in the housing and a second brake element rotatably arranged in the housing,
wherein the first brake element and the second brake element cooperate to generate a brake torque, and
wherein the brake torque generated by the brake device is adjustable by moving an adjustment element along an adjustment axis, wherein the adjustment element is accessible via a closable opening, provided in the first housing part, for adjusting the brake torque, wherein the adjustment element can be moved by a tool element and has a coupling portion which is provided for coupling to a counter-coupling portion provided on the tool element, wherein an external gear is provided in the coupling portion and in the counter-coupling portion of the tool element, and an external thread is provided configured for being brought into threaded engagement with the external gear.

20. The actuator according to claim 19, wherein the opening is configured to receive the tool element.

21. The actuator according to claim 20, wherein the tool element has an end portion provided for coupling to a manually-driven or motor-driven tool.

22. The actuator according to claim 21, wherein the end portion projects beyond an edge of the opening.

23. The actuator according to claim 19, wherein the adjustment element can be moved along the adjustment axis by rotation about the adjustment axis.

24. The actuator according to claim 19, wherein the coupling portion is arranged in the region of the opening so that the coupling portion is coupleable to the tool element for coupling.

25. The actuator according to claim 19, wherein the brake device is a hysteresis brake, wherein the first brake element is a multi-pole permanent magnet coupled in a rotationally fixed manner to the driveshaft or to a gearbox element coupled to the actuation element, and the second brake element is a film or a layer of a hysteresis material connected to the adjustment element.

26. The actuator according to claim 25, wherein the adjustment element is a hollow cylinder and has a film made of a hysteresis material on an inner side facing the permanent magnet running parallel to a side surface of the permanent magnet.

27. The actuator according to claim 26, wherein the film is spaced apart from the side surface of the permanent magnet by an air gap.

28. The actuator according to claim 19, wherein the adjustment element has an external thread configured for threaded engagement with an internal thread provided in the housing.

29. The actuator according to claim 28, wherein the external thread is arranged adjacently to the coupling portion.

30. A method for adjusting a brake torque generated by the brake device in the actuator according to claim 19, comprising:
determining an axial force required during an extension and retraction movement of the actuation element provided on the actuator;
comparing the measured axial force with a specified target value; and
adjusting the brake torque generated by the brake device, comprising:
inserting the tool element into the opening provided in the first housing part while coupling the coupling portion of the adjustment element to the counter-coupling portion of the tool element; and
rotating the tool element about an axis of rotation, wherein the rotation of the tool element leads to a movement of the adjustment element along an adjustment axis in the housing of the actuator, wherein the tool element is actuated until the brake torque generated by the brake device corresponds to a value predetermined by the target value of the axial force, wherein the adjustment axis and the axis of rotation are perpendicular to each other.
